(19) United States
(12) Patent Application Publication
(10) Pub. No.: US 2026/0032600 A1
(43) Pub. Date: Jan. 29, 2026

(54) METHOD AND APPARATUS FOR TRANSMITTING INDICATION INFORMATION, AND READABLE STORAGE MEDIUM

(71) Applicant: Beijing Xiaomi Mobile Software Co., Ltd., Beijing (CN)

(72) Inventor: Shengxiang GUO, Beijing (CN)

(73) Assignee: Beijing Xiaomi Mobile Software Co., Ltd., Beijing (CN)

(21) Appl. No.: 18/996,939

(22) PCT Filed: Jul. 28, 2022
(86) PCT No.: PCT/CN2022/108656

§ 371 Date: Jan. 17, 2025

(51) Int. Cl. H04W 52/14; H04W 52/36

(52) U.S. Cl. CPC H04W 52/146; H04W 52/367

(57) ABSTRACT

Provided in the present disclosure are a method and apparatus for transmitting indication information, and a readable storage medium. The method comprises: sending first capability information to a network device, wherein the first capability information is used for indicating whether a user equipment supports intelligent regulation and control of transmission power; in response to the user equipment supporting intelligent regulation and control of the transmission power, receiving indication information sent by the network device, wherein the indication information is used for instructing the user equipment to maintain a parameter threshold value required for uplink transmission; and determining the transmission power of the uplink transmission according to the parameter threshold value.

### CROSS-REFERENCE TO RELATED APPLICATIONS

This application is a national stage of International Application No. PCT/CN2022/108656, filed on Jul. 28, 2022, which is hereby incorporated by reference in its entirety.

### TECHNICAL FIELD

The present disclosure relates to the field of wireless communication technologies, and in particular, to a method and apparatus for transmitting indication information and a readable storage medium.

### BACKGROUND

Electromagnetic radiation of mobile terminal devices such as mobile phones, smart watches, computers and the like may affect human body safety. As 5G New Radio (NR) is going to be used for commercial purposes, mobile terminal devices supporting high frequency band and high power will become a major trend in the market, and electromagnetic radiation of mobile terminal devices supporting high frequency band and high power will increase the risk of affecting human body safety.

At present, the electromagnetic radiation standard of the mobile terminal device is indicated by parameters of an electromagnetic wave absorption ratio or Specific Absorption Rate (SAR), and a Maximum Permissible Exposure (MPE). The SAR is mainly used in a low frequency band, for example, a frequency band below 6 GHz; and the MPE is mainly used in a millimeter wave frequency band.

To reduce an impact of a signal transmitted by the mobile terminal device on human body safety, output power reduction may be adopted based on a transmit power, or an uplink duty cycle (UL Dutycycle) of the mobile terminal device may be reduced, to meet a requirement of the SAR or MPE. A problem of influence on uplink coverage capability in the process of reducing the influence of the mobile terminal device on the human body safety needs to be solved.

### SUMMARY

The present disclosure provides a method and apparatus for transmitting indication information, and a readable storage medium.

In a first aspect, the present disclosure provides a method for receiving indication information, performed by a user equipment (UE), including:
sending first capability information to a network device, where the first capability information indicates whether the UE supports intelligent control of transmit power; in a case that the UE supports the intelligent control of transmit power, receiving indication information sent by the network device, where the indication information indicates a parameter threshold required by the UE for uplink transmission; and determining a transmit power of the uplink transmission according to the parameter threshold.

In the method of the present disclosure, the network device may issue indication information for the UE supporting intelligent control of transmit power, and such UE acquires, according to the indication information, a parameter threshold required for maintaining uplink transmission, and determines a reasonable transmit power according to the parameter threshold. In such way, the UE can not only reduce the impact on human body safety caused by transmission based on the capability of intelligently controlling transmit power, but also reduce the impact on uplink coverage while meeting the requirement of the human body safety, thereby effectively meeting requirements for uplink transmission.

In some possible embodiments, the parameter threshold includes a minimum transmit power or a threshold for power management maximum power reduction (P-MPR) of the UE.

In some possible embodiments, determining the transmit power of the uplink transmission according to the parameter threshold includes:
determining the transmit power according to a minimum transmit power or a threshold for P-MPR.

In some possible embodiments, determining the transmit power according to the minimum transmit power or the threshold for P-MPR includes:
determining a minimum reserved power during control of transmit power according to the minimum transmit power or the threshold for P-MPR; and determining the transmit power greater than or equal to the minimum reserved power.

In some possible embodiments, the first capability information includes a bit indicating whether the intelligent control of transmit power is supported.

In some possible embodiments, receiving the indication information sent by the network device includes:
receiving radio resource control (RRC) signaling or downlink control information (DCI) sent by the network device, where the RRC signaling or the DCI is used to determine the indication information.

In some possible embodiments, the indication information indicates a parameter threshold required by the UE for uplink transmission in a frequency band corresponding to a single carrier; and
determining the transmit power of the uplink transmission according to the parameter threshold includes: determining, according to the parameter threshold, the transmit power of the uplink transmission in the frequency band corresponding to the single carrier.

In some possible embodiments, the indication information indicates a parameter threshold required by the UE for uplink transmission in an entire frequency band corresponding to intra-frequency-band multiple carriers; and
determining the transmit power of the uplink transmission according to the parameter threshold includes: determining, according to the parameter threshold, the transmit power of the uplink transmission in the entire frequency band corresponding to the intra-frequency-band multiple carriers.

In some possible embodiments, the indication information includes a parameter threshold required by the UE for uplink transmission in a frequency band corresponding to each of inter-frequency-band multiple carriers; and
determining the transmit power of the uplink transmission according to the parameter threshold includes: determining, according to the parameter threshold, the transmit power of the uplink transmission in the frequency band corresponding to the each of inter-frequency-band multiple carriers respectively.

In a second aspect, the present disclosure provides a method for sending indication information, performed by a network device, including:
receiving first capability information of a user equipment (UE), where the first capability information indicates whether the UE supports intelligent control of transmit power; and in a case that the UE supports the intelligent control of transmit power, sending indication information to the UE, where the indication information indicates a parameter threshold required by the UE for uplink transmission.

In the method of the present disclosure, the network device can acquire capability of the UE based on the first capability information, and issue the indication information to the UE with the capability of intelligently controlling transmit power. In such way, the UE acquires, according to the indication information, the parameter threshold required for maintaining uplink transmission, and determines reasonable transmit power according to the parameter threshold. Therefore, it is beneficial for the UE to reduce the impact of transmission on human body safety while reducing the impact on uplink coverage based on the capability of intelligent control of transmit power, so as to effectively meet the requirement of uplink transmission.

In some possible embodiments, the parameter threshold includes a minimum transmit power or a threshold for P-MPR.

In some possible embodiments, the method further includes:
determining the parameter threshold.

In some possible embodiments, determining the parameter threshold includes:
in a case that the UE performs uplink transmission in a frequency band corresponding to a single carrier, determining the parameter threshold in the frequency band corresponding to the single carrier.

In some possible embodiments, determining the parameter threshold includes:
in a case that the UE performs uplink transmission by using intra-frequency-band multiple carriers, determining the parameter threshold in an entire frequency band corresponding to the intra-frequency-band multiple carriers.

In some possible embodiments, determining the parameter threshold includes:
in a case that the UE performs uplink transmission by using inter-frequency-band multiple carriers, determining the parameter threshold in a frequency band corresponding to each of the inter-frequency-band multiple carriers respectively.

In some possible embodiments, in a case that the parameter threshold includes the threshold of P-MPR, determining the parameter threshold includes:
receiving second capability information of the UE, where the second capability information indicates a power class supported by the UE in a set frequency band; and determining the threshold of P-MPR corresponding to the set frequency band according to the power class.

In a third aspect, the present disclosure provides an apparatus for receiving indication information, where the apparatus may be configured to perform steps performed by the UE in any one of the first aspect or possible designs of the first aspect. The UE may implement functions in the above methods by using a hardware structure, a software module, or a combination of the hardware structure and the software module.

When the apparatus shown in the third aspect is implemented by using the software module, the apparatus may include a transceiving module and a processing module that are coupled to each other, where the transceiving module may be configured to support a communication apparatus in communicating, and the processing module may be configured to perform a processing operation on the communication apparatus, for example, generate information/message that needs to be sent, or process a received signal to obtain the information/message.

When steps in the first aspect are performed, the transceiving module is configured to send first capability information to a network device, where the first capability information indicates whether the UE supports intelligent control of transmit power.

The transceiving module is further configured to: in a case that the UE supports the intelligent control of transmit power, receive indication information sent by the network device, where the indication information indicates a parameter threshold required by the UE for uplink transmission; and
a processing module is configured to determine a transmit power of the uplink transmission according to the parameter threshold.

In a fourth aspect, the present disclosure provides an apparatus for sending indication information, where the apparatus may be configured to perform steps performed by network device in any one of the second aspect or possible designs of the second aspect. The network device may implement functions in the above methods by using a hardware structure, a software module, or a combination of the hardware structure and the software module.

When the apparatus shown in the fourth aspect is implemented by using a software module, the apparatus may include a transceiving module, and the transceiving module may be configured to support a communication apparatus in communicating.

When steps in the second aspect are performed, the transceiving module is configured to receive first capability information of a user equipment (UE), where the first capability information indicates whether the UE supports intelligent control of transmit power;
the transceiving module is further configured to: in a case that the UE supports the intelligent control of transmit power, send indication information to the UE, where the indication information indicates a parameter threshold required by the UE for uplink transmission.

In a fifth aspect, the present disclosure provides a communication device, including a processor and a memory, where the memory is configured to store a computer program, and the processor is configured to execute the computer program, to implement the first aspect or any possible design of the first aspect.

In a sixth aspect, the present disclosure provides a communication device, including a processor and a memory, where the memory is configured to store a computer program, and the processor is configured to execute the computer program, to implement the second aspect or any possible design of the second aspect.

In a seventh aspect, the present disclosure provides a computer-readable storage medium, where the computer-readable storage medium stores an instruction (or referred to as a computer program, a program), and when the instruction is called and executed on a computer, the computer is caused to implement the first aspect or any possible design of the first aspect.

In an eighth aspect, the present disclosure provides a computer-readable storage medium, where the computer-readable storage medium stores an instruction (or referred to as a computer program, a program), and when the instruction is called and executed on a computer, the computer is caused to implement the second aspect or any possible design of the second aspect.

It should be understood that the above general description and the following detailed description are only examples and illustrative, and do not limit the present disclosure.

### BRIEF DESCRIPTION OF DRAWINGS

The drawings described herein are used to provide a further understanding of the embodiments of the present disclosure, which constitute a part of the present disclosure, and the schematic embodiments of the embodiments of the present disclosure and the description thereof are used to describe the embodiments of the present disclosure, and do not constitute an improper limitation on the embodiments of the present disclosure.

The accompanying drawings, which are incorporated in and constitute a part of this specification, illustrate embodiments consistent with the embodiments of the present disclosure and together with the description serve to describe the principles of the embodiments of the present disclosure.

FIG. 1 is a schematic architectural diagram of a wireless communication system according to an embodiment of the present disclosure.

FIG. 2 is a flowchart of a method for transmitting indication information according to an example embodiment.

FIG. 3 is a flowchart of a method for receiving indication information according to an example embodiment.

FIG. 4 is a flowchart of another method for receiving indication information according to an example embodiment.

FIG. 5 is a flowchart of another method for receiving indication information according to an example embodiment.

FIG. 6 is a flowchart of another method for receiving indication information according to an example embodiment.

FIG. 7 is a flowchart of another method for receiving indication information according to an example embodiment.

FIG. 8 is a flowchart of a method for sending indication information according to an example embodiment.

FIG. 9 is a flowchart of another method for sending indication information according to an example embodiment.

FIG. 10 is a flowchart of another method for sending indication information according to an example embodiment.

FIG. 11 is a flowchart of another method for sending indication information according to an example embodiment.

FIG. 12 is a block diagram of an apparatus for receiving indication information according to an example embodiment.

FIG. 13 is a block diagram of a user equipment according to an example embodiment.

FIG. 14 is a block diagram of an apparatus for sending indication information according to an example embodiment.

FIG. 15 is a block diagram of a communication device according to an example embodiment.

### DETAILED DESCRIPTION

Embodiments of the present disclosure will be further described with reference to the accompanying drawings and specific embodiments.

Example embodiments will be described in detail herein, examples of which are illustrated in the accompanying drawings. When following description refers to the drawings, unless otherwise indicated, same numerals in different drawings indicate same or similar elements. The embodiments described in the following example embodiments do not represent all embodiments consistent with the embodiments of the present disclosure. Rather, they are merely examples of apparatuses and methods consistent with some aspects of the present disclosure as detailed in the appended claims.

The terminology used in the embodiments of the present disclosure is for the purpose of describing particular embodiments only and is not intended to limit the embodiments of the present disclosure. The singular forms “a/an”, “the”, and “said” used in the embodiments of the present disclosure and the appended claims are also intended to include plural forms unless the context clearly indicates other meanings. It should also be understood that the term “and/or” as used herein refers to and includes any or all possible combinations of one or more associated listed item.

It should be understood that although the terms “first”, “second”, “third”, etc., may be used to describe various information in the embodiments of the present disclosure, these information should not be limited to these terms. These terms are only used to distinguish a same type of information from each other. For example, without departing from the scope of the embodiments of the present disclosure, “first information” may also be referred to as “second information”, and similarly, “second information” may also be referred to as “first information”. Depending on context, the word “if” and “when” as used herein may be interpreted as “upon” or “in a case that” or “in response to determining”.

Embodiments of the present disclosure are described in detail below, examples of which are shown in the accompanying drawings, where the same or similar reference numerals denote the same or similar elements throughout. The embodiments described below with reference to the accompanying drawings are examples and are intended to explain the present disclosure, and cannot be construed as limiting the present disclosure.

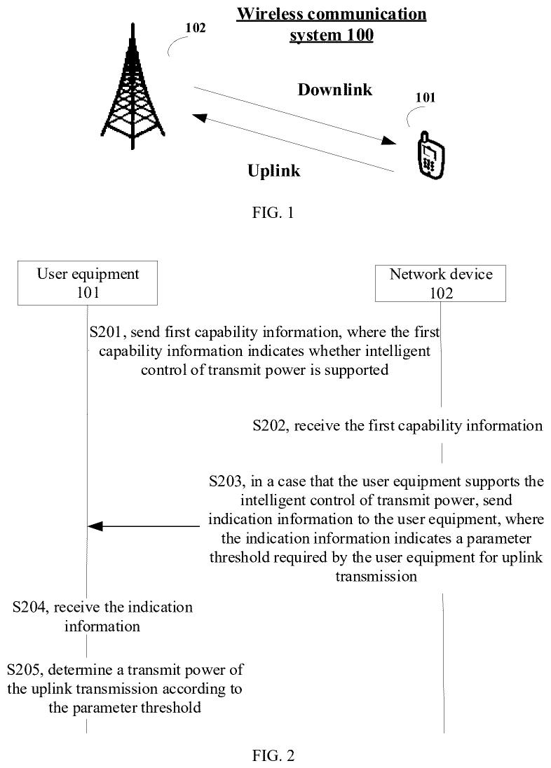

As shown in FIG. 1, a method for transmitting indication information provided in an embodiment of the present disclosure may be applied to a wireless communication system 100, where the wireless communication system may include a user equipment 101 and a network device 102. The user equipment 101 is configured to support carrier aggregation and may be connected to multiple carrier units of the network device 102, including one primary carrier unit and one or more secondary carrier units.

It should be understood that the above wireless communication system 100 may be applicable to both a low-frequency scenario and a high-frequency scenario. Application scenarios of the wireless communication system 100 include but are not limited to a long term evolution (LTE) system, an LTE frequency division duplex (FDD) system, an LTE time division duplex (TDD) system, a worldwide interoperability for micro wave access (WiMAX) communication system, a cloud radio access network (CRAN) system, a future fifth generation (5G) system, a new radio (NR) communication system, a future evolved public land mobile network (PLMN) system, or the like.

The user equipment 101 shown above may be a terminal, an access terminal, a terminal unit, a terminal station, a mobile station (MS), a remote station, a remote terminal, a mobile terminal, a wireless communication device, a terminal agent, a terminal device, or the like. The user equipment 101 may have a wireless transceiving function, and can communicate (for example, wirelessly communicate) with one or more network devices in one or more communication systems, and receive a network service provided by the network device, where the network device includes but is not limited to the illustrated network device 102.

The user equipment (UE) 101 may be a cellular phone, a cordless phone, a session initiation protocol (SIP) phone, a wireless local loop (WLL) station, a personal digital assistant (PDA) device, a handheld device having a wireless communication function, a computing device, another processing device connected to a wireless modem, an in-vehicle device, a wearable device, a terminal device in a future 5G network, a terminal device in a future evolved PLMN network, or the like.

The network device 102 may be an access network device (or referred to as an access network site). The access network device is a device that provides a network access function, for example, a radio access network (RAN) base station. The network device 102 may specifically include a base station (BS), a radio resource management device configured to control the base station, or the like. The network device 102 may further include a relay station (relay device), an access point, a base station in a future 5G network, a base station in a future evolved PLMN network, an NR base station, or the like. The network device 102 may be a wearable device or an in-vehicle device. The network device 102 may alternatively be a communication chip including a communication module.

For example, the network device 102 includes but is not limited to: a next generation base station (gNB) in 5G, an evolved node B (eNB) in an LTE system, a radio network controller (RNC), a node B (NB) in a WCDMA system, a radio controller in a CRAN system, a base station controller (BSC), a base transceiver station (BTS) in a GSM system or a CDMA system, a home base station (for example, a home evolved node B or a home node B, HNB), a baseband unit (BBU), a transmitting and receiving point (TRP), a transmitting point (TP), or a mobile switching center.

In a TS38.101-1 radio frequency standard of a 3rd Generation Partnership Project (3GPP), power management-maximum power reduction (P-MPR) of the UE is introduced, and the user equipment 101 needs to report a maximum uplink duty cycle capability (Maximum Dutycycle Capability) at a high power class, and when a scheduled uplink duty cycle is greater than a maximum uplink duty cycle, the user equipment 101 will reduce the transmit power class or reduce the transmit power. Therefore, the user equipment 101 can be effectively helped to reduce the influence on the human body safety.

However, the P-MPR is controlled by the manufacturer of the user equipment 101, so that the communication system cannot control the uplink coverage problem caused by the P-MPR of the user equipment 101. When the uplink coverage has a large impact, the uplink may even fail.

The user equipment 101 supporting the capability of intelligent control of the transmit power can control the transmit power to meet requirements of SAR or MPE by dynamically controlling the transmit power and using a time-averaged algorithm. For example, the user equipment 101 dynamically adjusts the transmit power in real time within a period of time, so that an average radio frequency power of the user equipment 101 within the period of time meets the requirements of SAR or MPE. This manner may affect a signal-to-noise ratio of a signal received by the network device 102, which may result in uplink failure.

An embodiment of the present disclosure provides a method for transmitting indication information. Referring to FIG. 2, FIG. 2 shows a method for transmitting indication information according to an example embodiment. As shown in FIG. 2, the method includes steps S201-S205.

Step S201, a user equipment 101 sends first capability information to a network device 102, where the first capability information indicates whether the user equipment 101 supports intelligent control of transmit power.

Step S202, the network device 102 receives the first capability information of the user equipment 101, where the first capability information indicates whether the user equipment 101 supports intelligent control of transmit power.

Step S203, in a case that the user equipment 101 supports the intelligent control of transmit power, the network device 102 sends indication information to the user equipment 101, where the indication information indicates a parameter threshold required by the user equipment 101 for uplink transmission.

Step S204, the user equipment 101 supporting the intelligent control of transmit power receives the indication information sent by the network device 102, where the indication information indicates a parameter threshold required by the user equipment 101 for uplink transmission.

Step S205, the user equipment 101 determines a transmit power of the uplink transmission according to the parameter threshold.

In some possible embodiments, the first capability information includes a bit indicating whether the intelligent control of transmit power is supported.

In an example, whether the user equipment 101 supports the intelligent control of transmit power is reported with 1-bit information in the first capability information.

In an example, the bit value being 1 indicates that the user equipment 101 supports the intelligent control of transmit power.

In an example, the bit value being 0 indicates that the user equipment 101 does not support the intelligent control of transmit power.

In some possible embodiments, the user equipment 101 supporting the intelligent control of transmit power may dynamically control the transmit power to meet requirements of human body safety, that is, to meet requirements of SAR or MPE.

In some possible embodiments, the network device 102 may carry the indication information in radio resource control (RRC) signaling.

In some possible embodiments, the network device 102 may carry the indication information in downlink control information (DCI).

In some possible embodiments, the parameter threshold indicated by the indication information represents a threshold for the intelligent control of transmit power for the user equipment 101, so that the adjusted transmit power can meet a requirement for maintaining the uplink transmission.

In some possible embodiments, the parameter threshold includes a minimum transmit power or a threshold for power management maximum power reduction (P-MPR) of the UE.

In an example, the parameter threshold includes a minimum transmit power Pmin.

In this example, during a process of intelligently controlling transmit power by the user equipment 101, when the transmit power is adjusted to meet the requirement of human body safety, a lower limit of the adjusted transmit power is not less than the minimum transmit power indicated by the parameter threshold. The minimum transmit power may not only meet the requirement of human body safety, but also meet a requirement for uplink transmission.

In an example, the parameter threshold includes a threshold of P-MPR, for example, denoted as P-MPR0.

In this example, during a process of intelligently controlling transmit power by the user equipment 101, an actual transmit power can be reduced through power reduction based on the transmit power. An upper limit of the power reduction is P-MPR0 indicated by the parameter threshold, so that the transmit power adjusted and obtained based on the power reduction can meet both the human body safety requirement and the uplink transmission requirement.

In some possible embodiments, the user equipment 101 determines a minimum reserved power Preserved according to the parameter threshold. The user equipment 101 intelligently controls the transmit power according to the minimum reserved power.

In an example, the transmit power for the uplink transmission may be greater than or equal to the minimum reserved power.

In the embodiments of the present disclosure, the network device 102 can acquire capability of the user equipment 101 based on the first capability information, and issue the indication information to the user equipment 101 with the capability of intelligently controlling transmit power. In such way, the user equipment 101 acquires, according to the indication information, the parameter threshold required for maintaining uplink transmission, and determines reasonable transmit power according to the parameter threshold. In such way, the user equipment 101 can not only reduce the impact on human body safety, caused by transmission, based on the capability of intelligently controlling transmit power, but also reduce the impact on uplink coverage while meeting the requirement of the human body safety, thereby effectively meeting requirements for uplink transmission.

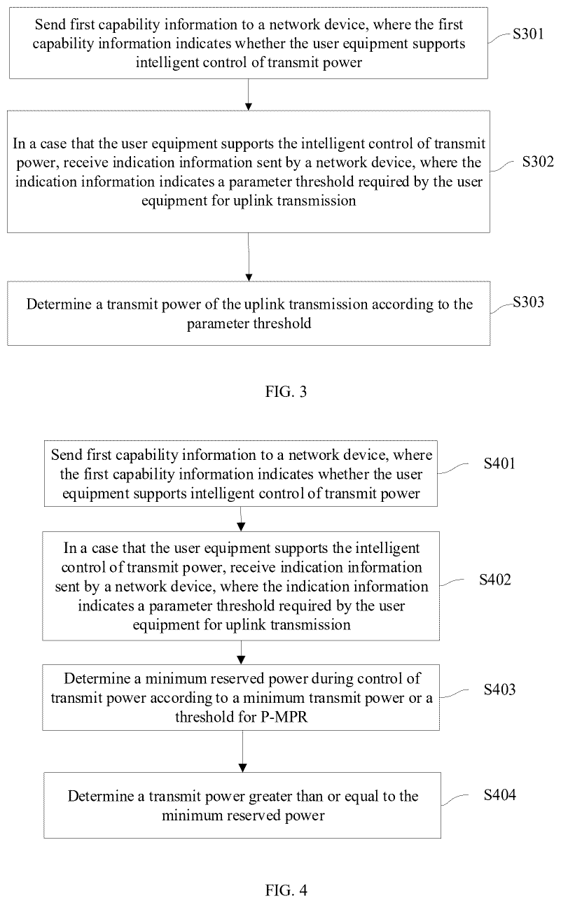

An embodiment of the present disclosure provides a method for receiving indication information, performed by a user equipment 101. Referring to FIG. 3, FIG. 3 shows a method for transmitting indication information according to an example embodiment. As shown in FIG. 3, the method includes steps S301-S303.

Step S301, a user equipment 101 sends first capability information to a network device 102, where the first capability information indicates whether the user equipment 101 supports intelligent control of transmit power.

Step S302, in a case that the user equipment 101 supports the intelligent control of transmit power, the user equipment 101 receives indication information sent by a network device 102, where the indication information indicates a parameter threshold required by the user equipment 101 for uplink transmission.

Step S303, the user equipment 101 determines a transmit power of the uplink transmission according to the parameter threshold.

In some possible embodiments, the first capability information includes a bit indicating whether the intelligent control of transmit power is supported.

In an example, whether the user equipment 101 supports the intelligent control of transmit power is reported with 1-bit information in the first capability information.

For example, the bit value being 1 indicates that the user equipment 101 supports the intelligent control of transmit power; and the bit value being 0 indicates that the user equipment 101 does not support the intelligent control of transmit power.

In some possible embodiments, the user equipment 101 supporting the intelligent control of transmit power may dynamically control the transmit power to meet requirements of human body safety, that is, to meet requirements of SAR or MPE.

In some possible embodiments, the parameter threshold represents a threshold for the intelligent control of transmit power for the user equipment 101, so that the adjusted transmit power can meet a requirement for maintaining the uplink transmission.

In some possible embodiments, the parameter threshold includes a minimum transmit power Pmin or a threshold for power management maximum power reduction (P-MPR) of the UE P-MPR0.

In some possible embodiments, the user equipment 101 determines a minimum reserved power Preserved according to the parameter threshold, and intelligently controls the transmit power according to the minimum reserved power.

In an example, the transmit power for the uplink transmission may be greater than or equal to the minimum reserved power.

In an example, the user equipment 101 determines the minimum reserved power Preserved for intelligent control of transmit power according to the minimum transmit power Pmin or P-MPR0.

In the embodiments of the present disclosure, the network device 102 may issue indication information for the user equipment 101 supporting intelligent control of transmit power, and such user equipment 101 acquires, according to the indication information, a parameter threshold required for maintaining uplink transmission, and determines a reasonable transmit power according to the parameter threshold. In such way, the user equipment 101 can not only reduce the impact on human body safety caused by transmission based on the capability of intelligently controlling transmit power, but also reduce the impact on uplink coverage while meeting the requirement of the human body safety, thereby effectively meeting requirements for uplink transmission.

An embodiment of the present disclosure provides a method for receiving indication information (not shown), performed by a user equipment 101. The method includes steps S301 to S303′.

Step S301, a user equipment 101 sends first capability information to a network device 102, where the first capability information indicates whether the user equipment 101 supports intelligent control of transmit power.

Step S302, in a case that the user equipment 101 supports the intelligent control of transmit power, the user equipment 101 receives indication information sent by a network device 102, where the indication information indicates a parameter threshold required by the user equipment 101 for uplink transmission.

Step S303′ (not shown), the user equipment 101 determines a transmit power according to a minimum transmit power or a threshold for P-MPR.

In some possible embodiments, the parameter threshold includes a minimum transmit power Pmin.

In an example, the minimum transmit power is estimated by the network device 102 according to a minimum receive signal-to-noise ratio or a minimum receive power required for maintaining the uplink transmission of the user equipment 101.

In an example, the network device 102 determines the minimum transmit power based on the minimum receive power and a path loss.

In an example, during a process of intelligently controlling transmit power by the user equipment 101, when the transmit power is adjusted to meet the requirement of human body safety, a lower limit of the adjusted transmit power is not less than the minimum transmit power indicated by the parameter threshold. The minimum transmit power may not only meet the requirement of human body safety, but also meet a requirement for uplink transmission.

In some possible embodiments, the parameter threshold includes a threshold P-MPR0 for P-MPR.

In an example, P-MPR0 is determined by the network device 102.

In an example, the network device 102 estimates the minimum transmit power according to a minimum receive signal-to-noise ratio or a minimum receive power required for maintaining the uplink communication of the user equipment 101, and determines P-MPR0 according to a power class P supported on a set frequency band reported by the user equipment 101. P-MPR0=P−Pmin.

The set frequency band may be a frequency band corresponding to a single carrier. Alternatively, the set frequency band is an entire frequency band corresponding to intra-frequency-band multiple carriers. Alternatively, the set frequency band represents a frequency band corresponding to each of inter-frequency-band multiple carriers.

In an example, during a process of intelligently controlling transmit power by the user equipment 101, an actual transmit power can be reduced through power reduction based on the transmit power. An upper limit of the power reduction is P-MPR0 indicated by the parameter threshold, so that the transmit power adjusted and obtained based on the power reduction can meet both the human body safety requirement and the uplink transmission requirement.

In the embodiments of the present disclosure, the user equipment 101 reports, to the network device 102, whether the user equipment 101 supports capability of intelligently controlling transmit power, and the network device 102 issues, to the user equipment 101, a minimum transmit power Pmin or P-MPR0 required for maintaining an uplink. In such way, the user equipment 101 determines a reasonable transmit power based on the minimum transmit power or the P-MPR0. Therefore, the user equipment 101 reduces an impact on uplink coverage while satisfying human body safety.

An embodiment of the present disclosure provides a method for receiving indication information, performed by a user equipment 101. Referring to FIG. 4, FIG. 4 shows a method for transmitting indication information according to an example embodiment. As shown in FIG. 4, the method includes steps S401-S404.

Step S401, a user equipment 101 sends first capability information to a network device 102, where the first capability information indicates whether the user equipment 101 supports intelligent control of transmit power.

Step S402, in a case that the user equipment 101 supports the intelligent control of transmit power, the user equipment 101 receives indication information sent by a network device 102, where the indication information indicates a parameter threshold required by the user equipment 101 for uplink transmission.

Step S403, the user equipment 101 determines a minimum reserved power during control of transmit power according to a minimum transmit power or a threshold for P-MPR.

Step S404, the user equipment 101 determines a transmit power greater than or equal to the minimum reserved power.

In some possible embodiments, the minimum reserved power represents a lower limit of the transmit power that needs to be maintained by the user equipment 101 in a process of intelligently controlling the transmit power, that is, the transmit power determined by the user equipment 101 for intelligent control should be greater than or equal to the minimum reserved power.

In some possible embodiments, the user equipment 101 determines the minimum reserved power Preserved according to the minimum transmit power Pmin.

In an example, the minimum reserved power Preserved satisfies: Preserved=Pmin+ΔP.

ΔP represents a tolerance value considered by the user equipment 101, which is a fixed value related to power control capability of the user equipment 101.

In some possible embodiments, the user equipment 101 determines the minimum reserved power Preserved according to the threshold P-MPR0 of P-MPR.

In an example, the minimum reserved power Preserved satisfies: Preserved=P−P-MPR0+ΔP.

P represents a power class supported on a set frequency band reported by the user equipment 101; ΔP represents a tolerance value considered by the user equipment 101, which is a fixed value related to power control capability of the user equipment 101.

In the embodiments of the present disclosure, the user equipment 101 determines the minimum reserved power based on the minimum transmit power Pmin issued by the network device 102 or the threshold P-MPR0 of P-MPR, where the minimum reserved power can effectively limit transmit power of the user equipment 101 in the intelligent control process, so that the user equipment 101 can determine a reasonable transmit power, to reduce impact on uplink coverage.

An embodiment of the present disclosure provides a method for receiving indication information (not shown), performed by a user equipment 101. The method includes steps S301, S302′ and S303.

Step S301, a user equipment 101 sends first capability information to a network device 102, where the first capability information indicates whether the user equipment 101 supports intelligent control of transmit power.

Step S302′ (not shown), in a case that the user equipment 101 supports the intelligent control of transmit power, the user equipment 101 receives radio resource control (RRC) signaling or downlink control information (DCI) sent by a network device 102, where the RRC signaling and DCI is used to determine indication information, where the indication information indicates a parameter threshold required by the user equipment 101 for uplink transmission.

Step S303, the user equipment 101 determines a transmit power of the uplink transmission according to the parameter threshold.

In some possible embodiments, the user equipment 101 determines the minimum transmit power Pmin or the threshold P-MPR0 of P-MPR based on the received RRC signaling or DCI.

In the embodiments of the present disclosure, the network device 102 issues the parameter threshold to the user equipment 101 by using RRC signaling or DCI, so that the user equipment 101 acquires the parameter threshold, and determines a reasonable transmit power based on the parameter threshold.

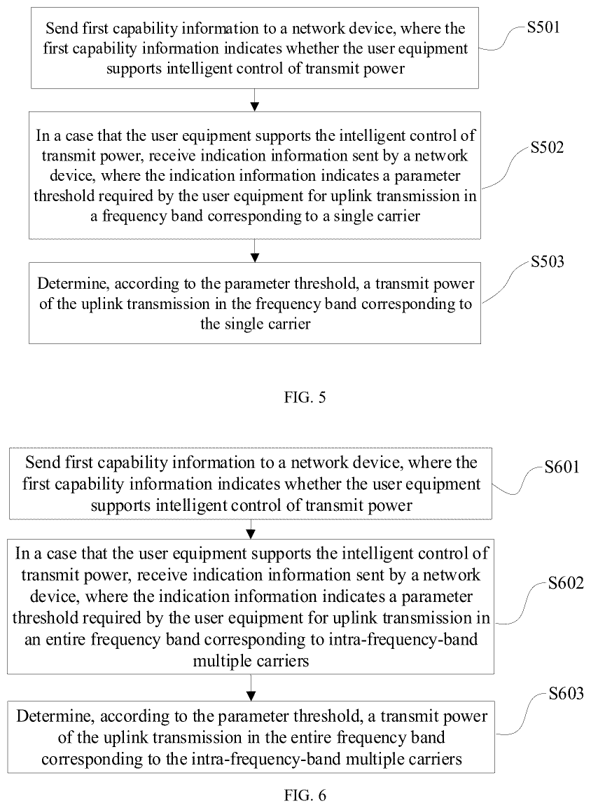

An embodiment of the present disclosure provides a method for receiving indication information, performed by a user equipment 101. Referring to FIG. 5, FIG. 5 shows a method for transmitting indication information according to an example embodiment. As shown in FIG. 5, the method includes steps S501-S503.

Step S501, a user equipment 101 sends first capability information to a network device 102, where the first capability information indicates whether the user equipment 101 supports intelligent control of transmit power.

Step S502, in a case that the user equipment 101 supports the intelligent control of transmit power, the user equipment 101 receives indication information sent by a network device 102, where the indication information indicates a parameter threshold required by the user equipment 101 for uplink transmission in a frequency band corresponding to a single carrier.

Step S503, the user equipment 101 determines, according to the parameter threshold, a transmit power of the uplink transmission in the frequency band corresponding to the single carrier.

In some possible embodiments, the indication information is applicable to the frequency band corresponding to the single carrier.

The parameter threshold corresponds to a minimum transmit power Pmin or a threshold P-MPR0 required by the user equipment 101 for uplink transmission in the frequency band corresponding to the single carrier.

In some possible embodiments, the user equipment 101 determines the minimum reserved power based on the minimum transmit power Pmin, and performs uplink transmission in the frequency band corresponding to the single carrier at a transmit power greater than or equal to the minimum reserved power.

In some possible embodiments, the user equipment 101 determines the minimum reserved power based on P-MPR0, and performs uplink transmission in the frequency band corresponding to the single carrier at a transmit power greater than or equal to the minimum reserved power.

In the embodiments of the present disclosure, in a single-carrier scenario, the network device 102 may issue, to the user equipment 101 supporting capability of intelligently controlling transmit power, the parameter threshold corresponding to the single-carrier, so that the user equipment 101 determines a reasonable transmit power in the frequency band corresponding to the single-carrier.

An embodiment of the present disclosure provides a method for receiving indication information, performed by a user equipment 101. Referring to FIG. 6, FIG. 6 shows a method for transmitting indication information according to an example embodiment. As shown in FIG. 6, the method includes steps S601-S603.

Step S601, a user equipment 101 sends first capability information to a network device 102, where the first capability information indicates whether the user equipment 101 supports intelligent control of transmit power.

Step S602, in a case that the user equipment 101 supports the intelligent control of transmit power, the user equipment 101 receives indication information sent by a network device 102, where the indication information indicates a parameter threshold required by the user equipment 101 for uplink transmission in an entire frequency band corresponding to intra-frequency-band multiple carriers.

Step S603, the user equipment 101 determines, according to the parameter threshold, a transmit power of the uplink transmission in the entire frequency band corresponding to the intra-frequency-band multiple carriers.

In some possible embodiments, the indication information is applicable to the entire frequency band corresponding to the intra-frequency-band multiple carriers, that is, a total bandwidth of the intra-frequency-band multiple carriers.

In some possible embodiments, the intra-frequency-band multiple carriers may be obtained based on co-band carrier aggregation of a multi-carrier system, for example, the intra-frequency-band multiple carriers include intra-band Carrier Aggregation. The multi-carrier system may be a carrier aggregation (CA) system, a dual connectivity (DC) system, or a multi-RAT (Radio Access Technology) dual-connectivity technology (MRDC), for example, an evolved universal terrestrial radio access network (E-UTRAN) and new radio dual connectivity (EN-DC) and a new radio (NR) and 4G radio access network dual connectivity (NE-DC).

In some possible embodiments, the parameter threshold corresponds to a minimum transmit power Pmin or a threshold P-MPR0 required by the user equipment 101 for uplink transmission in the entire frequency band corresponding to the intra-frequency-band multiple carriers.

In some possible embodiments, the user equipment 101 determines the minimum reserved power based on the minimum transmit power Pmin, and performs uplink transmission in the entire frequency band corresponding to the intra-frequency-band multiple carriers at a transmit power greater than or equal to the minimum reserved power.

In some possible embodiments, the user equipment 101 determines the minimum reserved power based on P-MPR0, and performs uplink transmission in the entire frequency band corresponding to the intra-frequency-band multiple carriers at a transmit power greater than or equal to the minimum reserved power.

In the embodiments of the present disclosure, in a scenario of intra-frequency-band multiple carriers in a multi-carrier system, the network device 102 may issue, to the user equipment 101 supporting capability of intelligently controlling transmit power, the parameter threshold applicable in the entire frequency band corresponding to the intra-frequency-band multiple carriers, so that the user equipment 101 determines a reasonable transmit power in the entire frequency band.

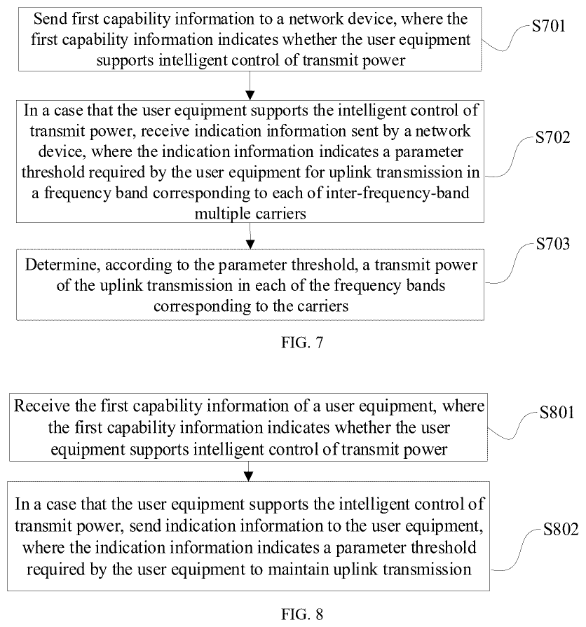

An embodiment of the present disclosure provides a method for receiving indication information, performed by a user equipment 101. Referring to FIG. 7, FIG. 7 shows a method for transmitting indication information according to an example embodiment. As shown in FIG. 7, the method includes steps S701-S703.

Step S701, a user equipment 101 sends first capability information to a network device 102, where the first capability information indicates whether the user equipment 101 supports intelligent control of transmit power.

Step S702, in a case that the user equipment 101 supports the intelligent control of transmit power, the user equipment 101 receives indication information sent by a network device 102, where the indication information indicates a parameter threshold required by the user equipment 101 for uplink transmission in a frequency band corresponding to each of inter-frequency-band multiple carriers.

Step S703, the user equipment 101 determines, according to the parameter threshold, a transmit power of the uplink transmission in each of the frequency bands corresponding to the carriers.

In some possible embodiments, the indication information is applicable to the frequency band corresponding to the each of inter-frequency-band multiple carriers.

In some possible embodiments, the inter-frequency-band multiple carriers may be obtained based on inter-frequency-band carrier aggregation of a multi-carrier system, for example, the inter-frequency-band multiple carriers include inter-band Carrier Aggregation. The multi-carrier system may be a CA system, a DC system, or a Muti-RAT Dual Connectivity, for example, EN-DC and NE-DC.

In some possible embodiments, the indication information includes a parameter threshold required by the user equipment 101 for uplink transmission in a frequency band corresponding to each of inter-frequency-band multiple carriers, and the parameter threshold may be a minimum transmit power Pmin or P-MPR0 of P-MPR corresponding to the frequency band corresponding to the each of inter-frequency-band multiple carriers.

In some possible embodiments, the user equipment 101 determines a minimum reserved power of a sub-frequency-band based on the minimum transmit power Pmin of the sub-frequency-band corresponding to each carrier, and performs uplink transmission in the sub-frequency-band corresponding to the carrier at a transmit power greater than or equal to the minimum reserved power.

In some possible embodiments, the user equipment 101 determines a minimum reserved power of a sub-frequency-band based on the P-MPR0 of the sub-frequency-band corresponding to each carrier, and performs uplink transmission in the sub-frequency-band at a transmit power greater than or equal to the minimum reserved power.

In the embodiments of the present disclosure, in a scenario of inter-frequency-band multiple carriers in a multi-carrier system, the network device 102 may issue, to the user equipment 101 supporting capability of intelligently controlling transmit power, the parameter threshold applicable in the frequency band corresponding to each of the inter-frequency-band multiple carriers, so that the user equipment 101 determines a reasonable transmit power in the frequency band corresponding to each of the carriers.

An embodiment of the present disclosure provides a method for sending indication information, performed by a network device 102. Referring to FIG. 8, FIG. 8 shows a method for sending indication information according to an example embodiment. As shown in FIG. 8, the method includes steps S801-S802.

Step S801, the network device 102 receives the first capability information of a user equipment 101, where the first capability information indicates whether the user equipment 101 supports intelligent control of transmit power.

Step S802, in a case that the user equipment 101 supports the intelligent control of transmit power, the network device 102 sends indication information to the user equipment 101, where the indication information indicates a parameter threshold required by the user equipment 101 for uplink transmission.

In some possible embodiments, the user equipment 101 may report, in the first capability information by using 1-bit information, whether intelligent control of transmit power is supported.

In some possible embodiments, the network device 102 sends radio resource control (RRC) signaling or downlink control information (DCI), where the RRC signaling or the DCI is used to determine the indication information.

In some possible embodiments, the parameter threshold includes a minimum transmit power Pmin or a threshold P-MPR0 for P-MPR.

In some possible embodiments, the indication information is applicable to a single-carrier system or a multi-carrier system.

In an example, the indication information indicates a parameter threshold of a frequency band corresponding to a single carrier. The user equipment 101 may determine a reasonable uplink transmit power in the frequency band corresponding to the single carrier according to the indication information.

In an example, the indication information indicates a parameter threshold of an entire frequency band corresponding to intra-frequency-band multiple carriers. The user equipment 101 may determine a reasonable uplink transmit power in the entire frequency band corresponding to the intra-frequency-band multiple carriers according to the indication information.

In an example, the indication information indicates a parameter threshold of a frequency band corresponding to each of inter-frequency-band multiple carriers. The user equipment 101 may determine a reasonable uplink transmit power in a frequency band corresponding to each of the inter-frequency-band multiple carriers according to the indication information.

In the embodiments of the present disclosure, the network device 102 can acquire capability of the user equipment 101 based on the first capability information, and issue the indication information to the user equipment 101 with the capability of intelligently controlling transmit power. In such way, the user equipment 101 acquires, according to the indication information, the parameter threshold required for maintaining uplink transmission, and determines reasonable transmit power according to the parameter threshold. Therefore, it is beneficial for the user equipment 101 to reduce the impact of transmission on human body safety while reducing the impact on uplink coverage based on the capability of intelligent control of transmit power, so as to effectively meet the requirement of uplink transmission.

An embodiment of the present disclosure provides a method for sending indication information, performed by a network device 102. The method includes steps S801, S802-1 and S802-2.

Step S801, the network device 102 receives the first capability information of the user equipment 101, where the first capability information indicates whether the user equipment 101 supports intelligent control of transmit power.

Step S802-1: in a case that the user equipment 101 supports the intelligent control of transmit power, the network device 102 determines a parameter threshold.

Step S802-2, the network device 102 sends indication information to the user equipment 101, where the indication information indicates the parameter threshold required by the user equipment 101 for uplink transmission.

In some possible embodiments, the parameter threshold includes a minimum transmit power Pmin or a threshold P-MPR0 for P-MPR.

In some possible embodiments, the network device 102 estimates and determines the minimum transmit power based on a minimum receive signal-to-noise ratio or a minimum receive power required for maintaining an uplink of the user equipment 101.

In an example, the network device 102 determines the minimum transmit power based on the minimum receive power and a path loss.

In some possible embodiments, the network device 102 estimates the minimum transmit power according to a minimum receive signal-to-noise ratio or a minimum receive power required for maintaining the uplink communication of the user equipment 101, and determines P-MPR0 according to a power class P supported on a set frequency band reported by the user equipment 101. P-MPR0=P−Pmin.

In an example, the power class P supported on the set frequency band reported by the user equipment 101 is PC1, and the network device 102 determines P-MPR0 based on a power (for example, −31 dbm) corresponding to the power class.

In an example, the user equipment 101 may carry the power class P by using second capability information that is to be reported.

In the embodiments of the present disclosure, the network device 102 predetermines a corresponding parameter threshold before sending the indication information, and then sends the parameter threshold to the user equipment 101 by using the indication information, so that the user equipment 101 determines a reasonable uplink transmit power based on the parameter threshold in a process of intelligently controlling the transmit power.

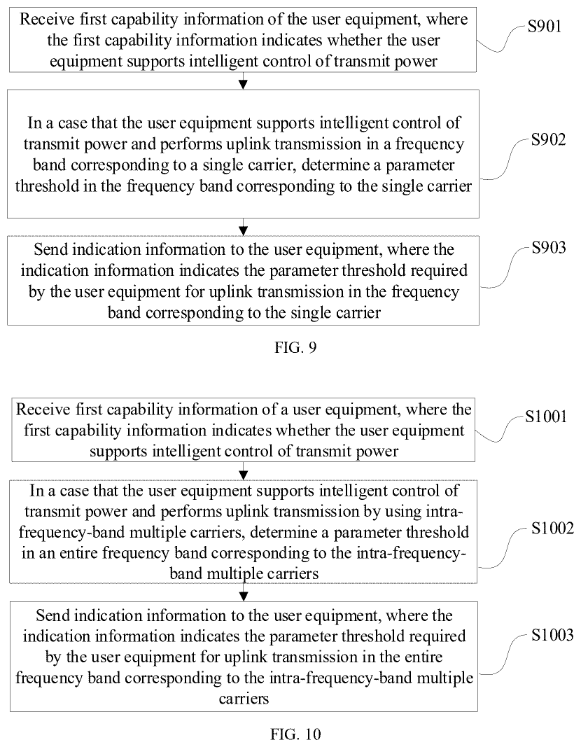

An embodiment of the present disclosure provides a method for sending indication information, performed by a network device 102. Referring to FIG. 9, FIG. 9 shows a method for sending indication information according to an example embodiment. As shown in FIG. 9, the method includes steps S901-S903.

Step S901, the network device 102 receives first capability information of a user equipment 101, where the first capability information indicates whether the user equipment 101 supports intelligent control of transmit power.

Step S902, in a case that the user equipment 101 supports intelligent control of transmit power and performs uplink transmission in a frequency band corresponding to a single carrier, the network device 102 determines a parameter threshold in the frequency band corresponding to the single carrier.

Step S903, the network device 102 sends indication information to the user equipment 101, where the indication information indicates the parameter threshold required by the user equipment 101 for uplink transmission in the frequency band corresponding to the single carrier.

In some possible embodiments, the parameter threshold corresponds to a minimum transmit power Pmin or a threshold P-MPR0 required by the user equipment 101 for uplink transmission in the frequency band corresponding to the single carrier.

In some possible embodiments, the network device 102 estimates and determines the minimum transmit power in the frequency band corresponding to the single carrier based on a minimum receive signal-to-noise ratio or a minimum receive power required for maintaining an uplink in the frequency band corresponding to the single carrier of the user equipment 101.

In some possible embodiments, the user equipment 101 reports a power class P supported in the frequency band corresponding to the single carrier. The network device 102 estimates the minimum transmit power according to the minimum receive signal-to-noise ratio or the minimum receive power required for maintaining the uplink of the user equipment 101 in the frequency band corresponding to the single carrier, and determines the P-MPR0 in the frequency band corresponding to the single carrier according to P corresponding to the frequency band of the single carrier reported by the user equipment 101.

In the embodiments of the present disclosure, the network device 102 may determine a parameter threshold corresponding to the user equipment 101 in a single-carrier scenario, so that the user equipment 101 determines a reasonable transmit power in the frequency band corresponding to the single carrier.

An embodiment of the present disclosure provides a method for sending indication information, performed by a network device 102. Referring to FIG. 10, FIG. 10 shows a method for sending indication information according to an example embodiment. As shown in FIG. 10, the method includes steps S1001-S1003.

Step S1001, the network device 102 receives first capability information of a user equipment 101, where the first capability information indicates whether the user equipment 101 supports intelligent control of transmit power.

Step S1002, in a case that the user equipment 101 supports intelligent control of transmit power and performs uplink transmission by using intra-frequency-band multiple carriers, the network device 102 determines a parameter threshold in an entire frequency band corresponding to the intra-frequency-band multiple carriers.

Step S1003, the network device 102 sends indication information to the user equipment 101, where the indication information indicates the parameter threshold required by the user equipment 101 for uplink transmission in the entire frequency band corresponding to the intra-frequency-band multiple carriers.

In some possible embodiments, the parameter threshold corresponds to a minimum transmit power Pmin or a threshold P-MPR0 required by the user equipment 101 for uplink transmission in the entire frequency band corresponding to the intra-frequency-band multiple carriers.

In some possible embodiments, the network device 102 estimates and determines the minimum transmit power in the entire frequency band corresponding to the intra-frequency-band multiple carriers based on a minimum receive signal-to-noise ratio or a minimum receive power required for maintaining an uplink in the entire frequency band corresponding to the intra-frequency-band multiple carriers of the user equipment 101.

In some possible embodiments, the user equipment 101 reports a power class P supported in the entire frequency band corresponding to the intra-frequency-band multiple carriers. The network device 102 estimates the minimum transmit power according to the minimum receive signal-to-noise ratio or the minimum receive power required for maintaining the uplink of the user equipment 101 in the entire frequency band corresponding to the intra-frequency-band multiple carriers, and determines the P-MPR0 in the entire frequency band corresponding to the intra-frequency-band multiple carriers according to P reported by the user equipment 101.

In the embodiments of the present disclosure, the network device 102 may determine a parameter threshold corresponding to the user equipment 101 in a scenario of intra-frequency-band multiple carriers in a multi-carrier system, so that the user equipment 101 determines a reasonable transmit power in the entire frequency band corresponding to the intra-frequency-band multiple carriers.

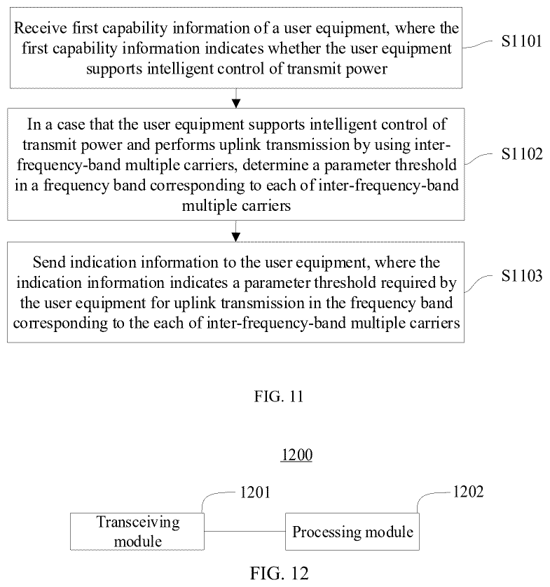

An embodiment of the present disclosure provides a method for sending indication information, performed by a network device 102. Referring to FIG. 11, FIG. 11 shows a method for sending indication information according to an example embodiment. As shown in FIG. 11, the method includes steps S1101-S1103.

Step S1101, the network device 102 receives first capability information of a user equipment 101, where the first capability information indicates whether the user equipment 101 supports intelligent control of transmit power.

Step S1102, in a case that the user equipment 101 supports intelligent control of transmit power and performs uplink transmission by using inter-frequency-band multiple carriers, the network device 102 determines a parameter threshold in a frequency band corresponding to each of inter-frequency-band multiple carriers.

Step S1103, the network device 102 sends indication information to the user equipment 101, where the indication information indicates a parameter threshold required by the user equipment 101 for uplink transmission in the frequency band corresponding to the each of inter-frequency-band multiple carriers.

In some possible embodiments, the indication information includes a parameter threshold required by the user equipment 101 for uplink transmission in a frequency band corresponding to each of inter-frequency-band multiple carriers, and the parameter threshold may be a minimum transmit power Pmin or P-MPR0 of P-MPR corresponding to the frequency band corresponding to the each of inter-frequency-band multiple carriers.

In some possible embodiments, the network device 102 estimates and determines the minimum transmit power in a sub-frequency band based on a minimum receive signal-to-noise ratio or a minimum receive power required for maintaining an uplink in the sub-frequency band corresponding to each of the inter-frequency-band multiple carriers of the user equipment 101.

In some possible embodiments, the user equipment 101 reports a power class P supported in the frequency band corresponding to each of the inter-frequency-band multiple carriers. For a frequency band corresponding to each carrier, the network device 102 estimates the minimum transmit power corresponding to the frequency band corresponding to the carrier according to the minimum receive signal-to-noise ratio or the minimum receive power required for maintaining the uplink of the user equipment 101 in the frequency band corresponding to the carrier, and determines the P-MPR0 of the frequency band corresponding to the carrier according to P corresponding to the frequency band corresponding to the carrier.

In the embodiments of the present disclosure, the network device 102 may determine a parameter threshold corresponding to the user equipment 101 in a frequency band corresponding to each carrier in a scenario of inter-frequency-band multiple carriers in a multi-carrier system, so that the user equipment 101 determines a reasonable transmit power in the frequency band corresponding to each carrier respectively.

An embodiment of the present disclosure provides a method for sending indication information (not shown), performed by a network device 102. The method includes steps S801, S802-1′, S802-1″ and S802-2.

Step S801, the network device 102 receives the first capability information of the user equipment 101, where the first capability information indicates whether the user equipment 101 supports intelligent control of transmit power.

Step S802-1′ (not shown): when the user equipment 101 supports intelligent control of transmit power, in a case that the parameter threshold is threshold P-MPR0 of P-MPR, the network device 102 receives second capability information of the user equipment 101, where the second capability information indicates a power class supported by the user equipment 101 on a set frequency band.

Step S802-1″ (not shown): the network device 102 determines, based on the power class, the threshold of the P-MPR corresponding to the set frequency band.

Step S802-2 (not shown), the network device 102 sends indication information to the user equipment 101, where the indication information indicates the parameter threshold required by the user equipment 101 for uplink transmission.

In some possible embodiments, the set frequency band may be a frequency band corresponding to a single carrier.

In an example, the user equipment 101 reports a power class supported in the frequency band corresponding to the single carrier. The network device 102 determines P-MPR0 in the frequency band corresponding to the single carrier based on the power class.

In some possible embodiments, the set frequency band may be a frequency band corresponding to intra-frequency-band multiple carriers.

In an example, the user equipment 101 reports a power class supported in the entire frequency band. The network device 102 determines P-MPR0 in the entire frequency band based on the power class.

Alternatively, the set frequency band represents a frequency band corresponding to each of inter-frequency-band multiple carriers.

In an example, the user equipment 101 may report a power class based on a frequency band corresponding to each carrier respectively, and the network device 102 distinguishes frequency bands corresponding to different carriers, to determine P-MPR0 of the frequency band corresponding to each carrier respectively.

In the embodiments of the present disclosure, the network device 102 may determine a reasonable P-MPR0 in a single-carrier or multi-carrier scenario, so that the user equipment 101 determines an appropriate uplink transmit power with reference to the corresponding P-MPR0.

Based on a same concept as the above method embodiments, an embodiment of the present disclosure further provides an apparatus for receiving indication information, where the apparatus may have a function of the user equipment 101 in the above method embodiments, and may be configured to perform steps performed by the user equipment 101 provided in the above method embodiments. The function may be implemented by hardware, or may be implemented by software or hardware executing corresponding software. The hardware or software includes one or more modules corresponding to the above functions.

In a possible implementation, the apparatus 1200 shown in FIG. 12 may be used as the user equipment 101 in the above method embodiments, and perform steps performed by the user equipment 101 in the above method embodiments. As shown in FIG. 12, the apparatus 1200 may include a transceiving module 1201 and a processing module 1202 that are coupled to each other, where the transceiving module 1201 may be configured to support a communication apparatus in communicating, and the processing module 1202 may be configured to perform a processing operation on the communication apparatus, for example, generate information/message that needs to be sent, or process a received signal to obtain the information/message.

When the steps of the user equipment 101 are performed, the transceiving module 1201 is configured to send first capability information to a network device 102, where the first capability information indicates whether the user equipment 101 supports intelligent control of transmit power.

The transceiving module 1201 is further configured to: in a case that the user equipment 101 supports the intelligent control of transmit power, receive indication information sent by the network device 102, where the indication information indicates a parameter threshold required by the user equipment 101 for uplink transmission.

The processing module 1202 is configured to determine a transmit power of the uplink transmission according to the parameter threshold.

In some possible embodiments, the parameter threshold includes a minimum transmit power or a threshold for power management maximum power reduction (P-MPR) of the UE.

In some possible implementations, the processing module 1202 is further configured to determine the transmit power based on the minimum transmit power or the threshold for P-MPR.

In some possible embodiments, the processing module 1202 is further configured to: determine, based on the minimum transmit power or the threshold for P-MPR, a minimum reserved power during a process of transmit power control; and determine a transmit power greater than or equal to the minimum reserved power.

In some possible embodiments, the first capability information includes a bit indicating whether the intelligent control of transmit power is supported.

In some possible embodiments, the transceiving module 1201 is further configured to: receive radio resource control (RRC) signaling or downlink control information (DCI) sent by the network device, where the RRC signaling or the DCI is used to determine the indication information.

In some possible embodiments, the indication information indicates a parameter threshold required by the user equipment for uplink transmission in a frequency band corresponding to a single carrier; and the processing module 1202 is further configured to determine the transmit power of the uplink transmission in the frequency band corresponding to the single carrier according to the parameter threshold.

In some possible embodiments, the indication information indicates a parameter threshold required by the user equipment for uplink transmission in an entire frequency band corresponding to intra-frequency-band multiple carriers; and the processing module 1202 is further configured to determine the transmit power of the uplink transmission in the entire frequency band corresponding to the intra-frequency-band multiple carriers according to the parameter threshold.

In some possible embodiments, the indication information includes: a parameter threshold required by the user equipment for uplink transmission in a frequency band corresponding to each of inter-frequency-band multiple carriers; and the processing module 1202 is further configured to determine the transmit power of the uplink transmission in the frequency band corresponding to the each of inter-frequency-band multiple carriers according to the parameter threshold.

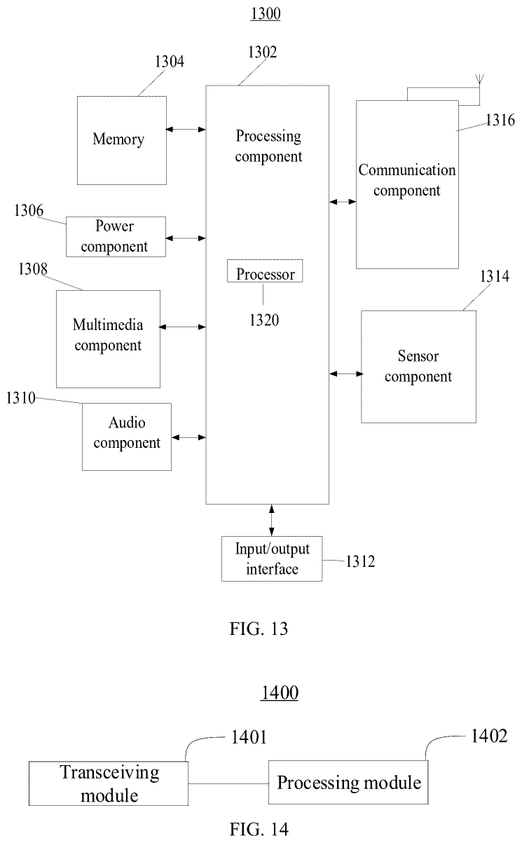

When the apparatus for receiving indication information is the user equipment 101, a structure thereof may also be as shown in FIG. 13. The apparatus 1300 may be a mobile phone, a computer, a digital broadcast terminal, a messaging device, a game console, a tablet device, a medical device, a fitness device, a personal digital assistant, or the like.

Referring to FIG. 13, the apparatus 1300 may include one or more of the following components: a processing component 1302, a memory 1304, a power component 1306, a multimedia component 1308, an audio component 1310, an input/output (I/O) interface 1312, a sensor component 1314, and a communication component 1316.

The processing component 1302 generally controls overall operations of the apparatus 1300, such as operations associated with display, telephone calls, data communications, camera operations, and recording operations. The processing component 1302 may include one or more processors 1320 to execute instructions to perform all or part of the steps of the above method. In addition, the processing component 1302 may include one or more modules to facilitate interaction between the processing component 1302 and other components. For example, the processing component 1302 may include a multimedia module to facilitate interaction between the multimedia component 1308 and the processing component 1302.

The memory 1304 is configured to store various types of data to support operations at the apparatus 1300. Examples of such data include instructions for any application or method, contact data, phonebook data, messages, pictures, videos, etc., operating on the apparatus 1300. The memory 1304 may be implemented by any type of volatile or non-volatile storage device or a combination thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic or optical disks.

The power component 1306 provides power to various components of the apparatus 1300. The power component 1306 may include a power management system, one or more power sources, and other components associated with generating, managing, and distributing power for the apparatus 1300.

The multimedia component 1308 includes a screen providing an output interface between the apparatus 1300 and the user. In some embodiments, the screen may include a liquid crystal display (LCD) and a touch panel (TP). If the screen includes a touch panel, the screen may be implemented as a touch screen to receive input signals from a user. The touch panel includes one or more touch sensors to sense touches, swipes, and gestures on the touch panel. The touch sensor may not only sense a boundary of a touch or slide action, but also detect a duration and pressure associated with the touch or slide operation. In some embodiments, the multimedia component 1308 includes a front camera and/or a rear camera. When the apparatus 1300 is in an operation mode, such as a photographing mode or a video mode, the front camera and/or the rear camera may receive external multimedia data. Each of the front camera and the rear camera may be a fixed optical lens system or have focal length and optical zoom capability.

The audio component 1310 is configured to output and/or input audio signals. For example, the audio component 1310 includes a microphone (MIC) configured to receive an external audio signal when the device 1000 is in an operation mode, such as a call mode, a recording mode, and a voice recognition mode. The received audio signal may be further stored in the memory 1304 or transmitted via the communication component 1316. In some embodiments, the audio component 1310 further includes a speaker configured to output an audio signal.

The I/O interface 1312 provides an interface between the processing component 1302 and peripheral interface modules, which may be keyboards, click wheels, buttons, etc. These buttons may include, but are not limited to, home buttons, volume buttons, start buttons, and lock buttons.

The sensor component 1314 includes one or more sensors for providing status assessments of various aspects of the apparatus 1300. For example, the sensor component 1314 may detect an open/closed state of the apparatus 1300, relative positioning of components, such as a display and a keypad of the apparatus 1300, a position change of the apparatus 1300 or a component of the apparatus 1300, a presence or absence of user contact with the apparatus 1300, an orientation or acceleration/deceleration of the apparatus 1300, and a temperature change of the apparatus 1300. The sensor component 1314 may include a proximity sensor configured to detect the presence of nearby objects without requiring any physical contact. The sensor component 1314 may also include a light sensor, such as a CMOS or CCD image sensor, for use in imaging applications. In some embodiments, the sensor component 1314 may further include an acceleration sensor, a gyroscope sensor, a magnetic sensor, a pressure sensor, or a temperature sensor.

The communication component 1316 is configured to facilitate wired or wireless communication between the apparatus 1300 and other devices. The apparatus 1300 may access a wireless network based on a communication standard, such as WiFi, 2G, or 3G, or a combination thereof. In an example embodiment, the communication component 1316 receives a broadcast signal or broadcast related information from an external broadcast management system via a broadcast channel. In an example embodiment, the communication component 1316 also includes a near field communication (NFC) module to facilitate short-range communication. For example, NFC modules may be implemented based on radio frequency identification (RFID) technology, infrared data association (IrDA) technology, ultra-wideband (UWB) technology, Bluetooth (BT) technology, and other technologies.

In an example embodiment, the apparatus 1300 may be implemented by one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, and is configured to perform the above methods.

In an example embodiment, there is further provided a non-transitory computer-readable storage medium including an instruction, such as a memory 1304 including the instruction, where the instruction is executable by a processor 1320 of the apparatus 1300 to perform the above method. For example, a non-transitory computer-readable storage medium may be a ROM, a random access memory (RAM), CD-ROM, magnetic tape, floppy disk, optical data storage device, and the like.

Based on a same concept as the above method embodiments, an embodiment of the present disclosure further provides an apparatus for sending indication information, where the apparatus may have a function of the network device 102 in the above method embodiments, and may be configured to perform steps performed by the network device 102 provided in the above method embodiments. The function may be implemented by hardware, or may be implemented by software or hardware executing corresponding software. The hardware or software includes one or more modules corresponding to the above functions.

In a possible implementation, the communication apparatus 1400 shown in FIG. 14 may be used as the network device 102 in the above method embodiments, and perform steps performed by the network device 102 in the above method embodiments. As shown in FIG. 14, the communication apparatus 1400 may include a transceiving module 1401 and a processing module 1402 that are coupled to each other, where the transceiving module 1401 may be configured to support the communication apparatus in communicating, and the transceiving module 1401 may have a wireless communication function, for example, can perform wireless communication with another communication apparatus through a wireless air interface. The processing module 1402 may be configured to perform a processing operation by the communication apparatus, for example, generate information/messages that need to be sent, or process a received signal to obtain information/messages.

When the steps of the network device 102 are performed, the transceiving module 1401 is configured to receive first capability information of a user equipment 101, where the first capability information indicates whether the user equipment 101 supports intelligent control of transmit power.

The transceiving module 1401 is further configured to: in a case that the user equipment 101 supports the intelligent control of transmit power, send indication information to the user equipment 101, where the indication information indicates a parameter threshold required by the user equipment for uplink transmission.

In some possible embodiments, the parameter threshold includes a minimum transmit power or a threshold for P-MPR.

In some possible embodiments, the processing module 1402 is configured to determine a parameter threshold.

In some possible embodiments, the processing module 1402 is further configured to determine, in a case that the user equipment performs uplink transmission in a frequency band corresponding to a single carrier, a parameter threshold in the frequency band corresponding to the single carrier.

In some possible embodiments, the processing module 1402 is further configured to determine, in a case that the user equipment performs uplink transmission by using intra-frequency-band multiple carriers, a parameter threshold in an entire frequency band corresponding to the intra-frequency-band multiple carriers.

In some possible embodiments, the processing module 1402 is further configured to determine, in a case that the user equipment performs uplink transmission by using inter-frequency-band multiple carriers, a parameter threshold in a frequency band corresponding to each of the inter-frequency-band multiple carriers respectively.

In some possible embodiments, in a case that the parameter threshold is a threshold of P-MPR, the processing module 1402 is further configured to: receive second capability information of the user equipment, where the second capability information indicates a power class supported by the user equipment on a set frequency band; and determine, based on the power class, the threshold of P-MPR corresponding to the set frequency band.

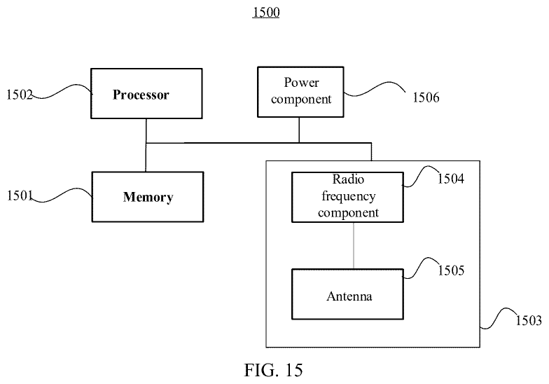

When the communication apparatus is the network device 102, a structure thereof may also be as shown in FIG. 15. A base station is taken as an example to describe a structure of the communication apparatus. As shown in FIG. 15, the apparatus 1500 includes a memory 1501, a processor 1502, a transceiving component 1503, and a power component 1506. The memory 1501 is coupled to the processor 1502, and may be configured to store a program and data necessary for the communication apparatus 1500 to implement each function. The processor 1502 is configured to support the communication apparatus 1500 in performing a corresponding function in the above method, and the function may be implemented by call the program stored in the memory 1501. The transceiving component 1503 may be a wireless transceiver, and may be configured to support the communication apparatus 1500 in receiving signaling and/or data through a wireless air interface, and sending signaling and/or data. The transceiving component 1503 may also be referred to as a transceiving unit or a communication unit, and the transceiving component 1503 may include a radio frequency component 1504 and one or more antennas 1505, where the radio frequency component 1504 may be a remote radio unit (RRU), and may be specifically configured for transmission of a radio frequency signal and conversion between a radio frequency signal and a baseband signal, and the one or more antennas 1505 may be specifically configured to perform radio frequency signal radiation and reception.

When the communication apparatus 1500 needs to send data, the processor 1502 may perform baseband processing on to-be-sent data and then output a baseband signal to the radio frequency unit, and the radio frequency unit performs radio frequency processing on the baseband signal and then sends the radio frequency signal in a form of an electromagnetic wave by using the antenna. When data is sent to the communication apparatus 1500, the radio frequency unit receives a radio frequency signal by using the antenna, converts the radio frequency signal into a baseband signal, and outputs the baseband signal to the processor 1502.

Other embodiments of the present disclosure will easily occur to those skilled in the art after considering the specification and practicing the present disclosure herein. The present disclosure is intended to cover any variations, uses or adaptations of the embodiments of the present disclosure, which follow the general principles of the embodiments of the present disclosure and include common sense or common technical means in this technical field that are not disclosed in the present disclosure. The specification and examples are to be regarded as examples only, with the true scope and spirit of the embodiments of the present disclosure being indicated by the following claims.

It should be understood that the embodiments of the present disclosure are not limited to the precise structures described above and shown in the accompanying drawings, and various modifications and changes may be made without departing from the scope thereof. The scope of embodiments of the present disclosure is limited only by the appended claims.

### INDUSTRIAL UTILITY

In the method disclosed in the present disclosure, the network device can acquire the capability of the user equipment based on the first capability information, and sends the indication information to the user equipment supporting the capability of intelligently controlling the transmit power. In such way, the user equipment acquires, according to the indication information, the parameter threshold required for maintaining uplink transmission, and determines reasonable transmit power according to the parameter threshold. Therefore, it is beneficial for the user equipment to reduce the impact of transmission on human body safety while reducing the impact on uplink coverage based on the capability of intelligent control of transmit power, so as to effectively meet the requirement of uplink transmission.

1. A method for receiving indication information, performed by a user equipment (UE), comprising:
sending first capability information to a network device, wherein the first capability information indicates whether the UE supports intelligent control of transmit power;
in a case that the UE supports the intelligent control of transmit power, receiving indication information sent by the network device, wherein the indication information indicates a parameter threshold required by the UE for uplink transmission; and
determining a transmit power of the uplink transmission according to the parameter threshold.

2. The method according to claim 1, wherein
the parameter threshold comprises a minimum transmit power or a threshold for power management maximum power reduction (P-MPR) of the UE.

3. The method according to claim 1, wherein
determining the transmit power of the uplink transmission according to the parameter threshold comprises:
determining a minimum reserved power during control of transmit power according to the minimum transmit power or the threshold for P-MPR; and
determining the transmit power greater than or equal to the minimum reserved power.

4. (canceled)

5. The method according to claim 1, wherein the first capability information comprises a bit indicating whether the intelligent control of transmit power is supported.

6. The method according to claim 1, wherein
receiving the indication information sent by the network device comprises:
receiving radio resource control (RRC) signaling or downlink control information (DCI) sent by the network device, wherein the RRC signaling or the DCI is used to determine the indication information.

7. The method according to claim 1, wherein
determining the transmit power of the uplink transmission according to the parameter threshold comprises at least one of:
determining, according to the parameter threshold, the transmit power of the uplink transmission in the frequency band corresponding to the single carrier, wherein the indication information indicates the parameter threshold required by the UE for uplink transmission in a frequency band corresponding to a single carrier;
determining, according to the parameter threshold, the transmit power of the uplink transmission in the entire frequency band corresponding to the intra-frequency-band multiple carriers, wherein the indication information indicates the parameter threshold required by the UE for uplink transmission in a frequency band corresponding to each of at least two of intra-band carriers; or
determining, according to the parameter threshold, the transmit power of the uplink transmission in the frequency band corresponding to each of the inter-frequency-band multiple carriers respectively, wherein the indication information comprises the parameter threshold required by the UE for uplink transmission in a frequency band corresponding to each of at least two of inter-band carriers.

8-9. (canceled)

10. A method for sending indication information, performed by a network device, comprising:
receiving first capability information of a user equipment (UE), wherein the first capability information indicates whether the UE supports intelligent control of transmit power; and
in a case that the UE supports the intelligent control of transmit power, sending indication information to the UE, wherein the indication information indicates a parameter threshold required by the UE for uplink transmission.

11. The method according to claim 10, wherein
the parameter threshold comprises a minimum transmit power or a threshold for power management maximum power reduction (P-MPR) of the UE.

12. The method according to claim 10, further comprising:
determining the parameter threshold.

13. The method according to claim 12, wherein
determining the parameter threshold comprises:
in a case that the UE performs uplink transmission in a frequency band corresponding to a single carrier, determining the parameter threshold in the frequency band corresponding to the single carrier.

14. The method according to claim 12, wherein
determining the parameter threshold comprises:
in a case that the UE performs uplink transmission by using intra-frequency-band multiple carriers, determining the parameter threshold in an entire frequency band corresponding to the intra-frequency-band multiple carriers.

15. The method according to claim 12, wherein
determining the parameter threshold comprises:
in a case that the UE performs uplink transmission by using inter-frequency-band multiple carriers, determining the parameter threshold in each of frequency bands corresponding to the inter-frequency-band multiple carriers respectively.

16. The method according to claim 12, wherein
in a case that the parameter threshold comprises the threshold of P-MPR, determining the parameter threshold comprises:
receiving second capability information of the UE, wherein the second capability information indicates a power class supported by the UE in a set frequency band; and
determining the threshold of P-MPR corresponding to the set frequency band according to the power class.

17-18. (canceled)

19. A communication device, comprising a processor and a memory, wherein
the memory is configured to store a computer program;
the processor is configured to execute the computer program to implement the method according to claim 1.

20. A communication device, comprising a processor and a memory, wherein
the memory is configured to store a computer program;
the processor is configured to execute the computer program to implement the method according to claim 10.

21. A non-transitory computer-readable storage medium, storing an instruction, wherein when the instruction is called and executed on a computer, the computer is caused to perform the method according to claim 1.

22. A non-transitory computer-readable storage medium, storing an instruction, wherein when the instruction is called and executed on a computer, the computer is caused to perform the method according to claim 10.
